(19) United States
(12) Patent Application Publication
(10) Pub. No.: US 2026/0134845 A1
(43) Pub. Date: May 14, 2026

(54) LOW-FLASH ELECTROPHORETIC DISPLAY UPDATES USING NOISE MASKS FOR WAVEFORM INITIATION

(71) Applicant: E Ink Corporation, Billerica, MA (US)

(72) Inventors: Craig LIN, Fremont, CA (US); Bryan Hans CHAN, San Francisco, CA (US); Hossein MORADIAN, Milpitas, CA (US); Muhanad JALIL, Tracy, CA (US)

(21) Appl. No.: 19/386,520

(22) Filed: Nov. 12, 2025

Related U.S. Application Data
(60) Provisional application No. 63/720,048, filed on Nov. 13, 2024.

(51) Int. Cl. G09G 3/34; G02F 1/167; G02F 1/1675; G09G 3/20

(52) U.S. Cl. CPC G09G 3/344; G02F 1/167; G02F 1/1675; G09G 3/2092; G02F 2001/1678; G09G 2310/068; G09G 2320/0242; G09G 2320/0247

(57) ABSTRACT

Methods to decrease the “flashiness” of updates in electrophoretic displays, especially color electrophoretic displays by incorporating spatial-temporal masks and/or phase shifts in the waveforms. The methods allow for a per pixel start time to begin a color update at each pixel with little cost in the way of processing power or energy consumption. In alternate embodiments selected images, e.g., logos, may be embedded into the transition appearance. The methods are generalizable to any electrophoretic display using waveforms and are particularly well-suited for newer multi-particle electrophoretic displays capable of producing four or more colors at each pixel.

### RELATED APPLICATIONS

This application claims priority to U.S. Provisional Patent Application No. 63/720,048, filed Nov. 13, 2024. All patents and publications disclosed herein are incorporated by reference in their entireties.

### BACKGROUND

An electrophoretic display (EPD) changes color by modifying the position of one or more charged colored particles with respect to a light-transmissive viewing surface. Such electrophoretic displays are typically referred to as “electronic paper” or “ePaper” because the resulting display has high contrast and is sunlight-readable, much like ink on paper. Electrophoretic displays have enjoyed widespread adoption in eReaders because the electrophoretic displays provide a book-like reading experience, use little power, and allow a user to carry a library of hundreds of books in a lightweight handheld device. Such devices are increasingly being adapted to display out-of-home (OOH) digital content, such as shelf labels, outdoor advertisement and transportation signage.

For many years, electrophoretic displays included only two types of charged color particles, black and white. (To be sure, “color” as used herein includes black and white.) The white particles are often of light-scattering, and comprise, e.g., titanium dioxide, while the black particles are absorptive across the visible spectrum, and may comprise carbon black, or an absorptive metal oxide, such as copper chromite. In the simplest sense, a black and white electrophoretic display only requires a light-transmissive electrode at the viewing surface, a back electrode, and an electrophoretic medium including oppositely charged white and black particles. When a voltage of one polarity is provided, the white particles move to the viewing surface, and when a voltage of the opposite polarity is provided the black particles move to the viewing surface. If the back electrode includes controllable regions (pixels)—either segmented electrodes or an active matrix of pixel electrodes controlled by transistors—a pattern can be made to appear electronically at the viewing surface. The pattern can be, for example, the text to a book.

More recently, a variety of color options have become commercially available for electrophoretic displays, including three-color displays (black, white, red; black white, yellow), and four color displays (black, white, red, yellow). Similar to the operation of black and white electrophoretic displays, electrophoretic displays with three or four reflective pigments operate similar to the simple black and white displays because the desired color particle is driven to the viewing surface. The driving schemes are far more complicated than only black and white, but in the end, the optical function of the particles is the same. The Spectra 6 platform from E Ink Corporation uses a semi-transparent blue particle that can be mixed with other reflective particles at the viewing surface to produce more colors than the native red, yellow, blue, and white. For example, mixing the blue and the red particles creates a black state at the viewing surface, while mixing the blue and yellow particles creates a green state at the viewing surface. More details of this system are available in the following U.S. Patents, all of which are incorporated by reference in their entireties: U.S. Pat. Nos. 9,922,603, 11,640,803, and 11,868,020.

Advanced Color electronic Paper (ACeP™) also includes four particles, but the cyan, yellow, and magenta particles are subtractive rather than reflective, thereby allowing thousands of colors to be produced at each pixel. The color process is functionally equivalent to the printing methods that have long been used in offset printing and ink-jet printers. A given color is produced by using the correct ratio of cyan, yellow, and magenta on a bright white paper background. In the instance of ACeP, the relative positions of the cyan, yellow, magenta and white particles with respect to the viewing surface will determine the color at each pixel. While this type of electrophoretic display allows for thousands of colors at each pixel, it is critical to carefully control the position of each of the (50 to 500 nanometer-sized) pigments within a working space of about 10 to 20 micrometers in thickness. Obviously, variations in the position of the pigments will result in incorrect colors being displayed at a given pixel. Accordingly, exquisite voltage control is required for such a system. More details of this system are available in the following U.S. Patents, all of which are incorporated by reference in their entireties: U.S. Pat. Nos. 9,361,836, 9,921,451, 10,276,109, 10,353,266, 10,467,984, 10,593,272, and 10,657,869.

As described in the aforementioned patents, the waveforms (i.e., electric fields provided across the electrophoretic medium as a function of time) typically require substantial swings in voltage polarity in a short time. Because of this, in some instances, the colored electrophoretic display “flashes,” “flickers,” or “looks flashy” when switching between color images. This shortcoming is particularly pronounced when a large (25″ diagonal or larger) full-color display is quickly switched. U.S. Pat. No. 10,657,869 addressed a similar issue, however the '869 patent does not suggest to use look up tables to store offset waveforms, as described below. Other patents owned by E Ink Corporation, such as U.S. Pat. No. 8,593,396 also provided solutions for shifting the initiation of a waveform or reducing (or increasing) the size of the waveform in order to improve gray scale control, however these patents did not appreciate that such adjustments would decrease flash when properly coordinated.

The following disclosure relates to color electrophoretic displays, especially, but not exclusively, to electrophoretic displays capable of rendering more than two colors using a single layer of electrophoretic material comprising a plurality of colored particles, for example white, cyan, yellow, and magenta particles. In some instances, two of the particles will be positively-charged, and one (or two) of the particles will be negatively-charged. In some instances, one of the particles will be positively-charged, and three particles will be negatively-charged. In some instances, one of the particles will be negatively-charged, and three particles will be positively-charged. The particles may additionally differ in the type of charge species on the particle surface and/or the type of polymer(s) functionalized on the surface. The particles may comprise organic or inorganic pigments or dyes.

The term gray state is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate gray state would actually be pale blue. Indeed, as already mentioned, the change in optical state may not be a color change at all. The terms black and white may be used hereinafter to refer to the two extreme optical states of a display and should be understood as normally including extreme optical states which are not strictly black and white, for example the aforementioned white and dark blue states.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays.

The term impulse, when used to refer to driving an electrophoretic display, is used herein to refer to the integral of the applied voltage with respect to time during the period in which the display is driven.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Particle-based electrophoretic displays have been the subject of intense research and development for a number of years. In such displays, a plurality of charged particles (sometimes referred to as pigment particles) move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777 (these patents and applications may hereinafter be referred to as the MEDEOD (MEthods for Driving Electro-optic Displays) applications);
(i) Applications of displays; see for example U.S. Pat. Nos. 7,312,784 and 8,009,348; and
(j) Non-electrophoretic displays, as described in U.S. Pat. No. 6,241,921; and U.S. Patent Applications Publication Nos. 2015/0277160; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449.

Although electrophoretic media are often opaque (since, for example, in many electrophoretic media, the particles substantially block transmission of visible light through the display) and operate in a reflective mode, many electrophoretic displays can be made to operate in a so-called shutter mode in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

As indicated above, most simple prior art electrophoretic media essentially display only two colors. Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid (in which case, the first color is displayed when the first type of particles lie adjacent the viewing surface of the display and the second color is displayed when the second type of particles lie adjacent the viewing surface). Typically, the two colors are black and white. If a full color display is desired, a color filter array may be deposited over the viewing surface of the monochrome (black and white) display. Displays with color filter arrays rely on area sharing and color blending to create color stimuli. The available display area is shared between three or four primary colors such as red/green/blue (RGB) or red/green/blue/white (RGBW), and the filters can be arranged in one-dimensional (stripe) or two-dimensional (2×2) repeat patterns. Other choices of primary colors or more than three primaries are also known in the state of the art. The three (in the case of RGB displays) or four (in the case of RGBW displays) sub-pixels are chosen small enough so that at the intended viewing distance they visually blend together to a single pixel with a uniform color stimulus (‘color blending’). The inherent disadvantage of area sharing is that the colorants are always present, and colors can only be modulated by switching the corresponding pixels of the underlying monochrome display to white or black (switching the corresponding primary colors on or off). For example, in an ideal RGBW display, each of the red, green, blue and white primaries occupy one fourth of the display area (one sub-pixel out of four), with the white sub-pixel being as bright as the underlying monochrome display white, and each of the colored sub-pixels being no lighter than one third of the monochrome display white. The brightness of the white color shown by the display as a whole cannot be more than one half of the brightness of the white sub-pixel (white areas of the display are produced by displaying the one white sub-pixel out of each four, plus each colored sub-pixel in its colored form being equivalent to one third of a white sub-pixel, so the three colored sub-pixels combined contribute no more than the one white sub-pixel). The brightness and saturation of colors is lowered by area-sharing with color pixels switched to black. Area sharing is especially problematic when mixing yellow because it is lighter than any other color of equal brightness, and saturated yellow is almost as bright as white. Switching the blue pixels (one fourth of the display area) to black makes the yellow too dark.

U.S. Pat. Nos. 8,576,476 and 8,797,634 describe multicolor electrophoretic displays having a single back plane comprising independently addressable pixel electrodes and a common, light-transmissive front electrode. Between the back plane and the front electrode is disposed a plurality of electrophoretic layers. Displays described in these applications are capable of rendering any of the primary colors (red, green, blue, cyan, magenta, yellow, white and black) at any pixel location. However, there are disadvantages to the use of multiple electrophoretic layers located between a single set of addressing electrodes. The electric field experienced by the particles in a particular layer is lower than would be the case for a single electrophoretic layer addressed with the same voltage. In addition, optical losses in an electrophoretic layer closest to the viewing surface (for example, caused by light scattering or unwanted absorption) may affect the appearance of images formed in underlying electrophoretic layers.

Attempts have been made to provide full-color electrophoretic displays using a single electrophoretic layer. For example, U.S. Pat. No. 8,917,439 describes a color display comprising an electrophoretic fluid that comprises one or two types of pigment particles dispersed in a clear and colorless or colored solvent, the electrophoretic fluid being disposed between a common electrode and a plurality of pixel or driving electrodes. The driving electrodes are arranged to expose a background layer. U.S. Pat. No. 9,116,412 describes a method for driving a display cell filled with an electrophoretic fluid comprising two types of charged particles carrying opposite charge polarities and of two contrast colors. The two types of pigment particles are dispersed in a colored solvent or in a solvent with non-charged or slightly charged colored particles dispersed therein. The method comprises driving the display cell to display the color of the solvent or the color of the non-charged or slightly charged colored particles by applying a driving voltage that is about 1 to about 20% of the full driving voltage. U.S. Pat. Nos. 8,717,664 and 8,964,282 describe an electrophoretic fluid, and a method for driving an electrophoretic display. The fluid comprises first, second and third type of pigment particles, all of which are dispersed in a solvent or solvent mixture. The first and second types of pigment particles carry opposite charge polarities, and the third type of pigment particles has a charge level being less than about 50% of the charge level of the first or second type. The three types of pigment particles have different levels of threshold voltage, or different levels of mobility, or both.

Electrophoretic displays capable of rendering any color at any pixel location have been described in U.S. Pat. Nos. 10,475,399 and 10,678,111. In the '399 patent, a display is described in which a white (light-scattering) pigment moves in a first direction when addressed with a low applied voltage and in the opposite direction when addressed with a higher voltage. In the '111 patent, a full-color electrophoretic display is described in which there are four pigments: white, cyan, magenta and yellow, in which two of the pigments are positively-charged and two negatively charged. U.S. Patent Publication 2022/0082896 describes a full-color electrophoretic display in which there are four pigments: white, cyan, magenta and yellow, in which the three colored pigments are positively-charged and white pigment negatively charged. Embodiments of the present invention of this type are referred to as CMYW embodiments.

In addition, there are multi-particle display designs in which the color pigments scatter light (i.e., reflective color particles). U.S. Pat. No. 10,339,876 describes a display of this type having black, white and red particles capable of rendering three states. Similar display designs including four pigments can render four different colors, see, e.g. U.S. Pat. No. 9,922,603, or, by using a semi-transparent colored particle, such displays can render six colors, see, e.g., U.S. Pat. No. 11,640,803. Many of the multi-particle display designs using light-scattering particles incorporate lengthy and “flashy” updates, which some viewers find unappealing.

Typically, an electrophoretic display (EPD) update uses a look-up-table that translates a pixel gray tone (or color transition) to a series of electrical pulses. In a typical active matrix, thin-film-transistor (TFT)-controlled display, all of the pixels begin their updates at (approximately) the same starting time. That is, all of the transitions begin with the same frame, wherein a “frame” is the time it takes to address each pixel electrode in an active matrix in a row-by-row fashion. When done this way, the updates can appear “flashy” because all of the pixels are simultaneously changing, and in many cases all of the pixels are going through the same colors simultaneously.

One trick to decrease the flash is to distribute the starting times over space so that the overall effect is not as flashy. As an example, there are implementations that allow for 16, 32, or 64 regions with staggered start times. See, e.g., U.S. Pat. No. 10,832,622, which is incorporated by reference in its entirety. However, as done conventionally, each additional region requires more memory and processor speed, which adds cost and increases power consumption. Additionally, the software needed to track large numbers of regions is burdensome for the host system controller. Essentially, keeping track of what pixels have what colors at what time becomes cumbersome as the image is diced into smaller updating regions. Accordingly, the number of regions has typically been limited to 64 regions or less.

### SUMMARY

Disclosed herein are improved methods of updating color electrophoretic displays and color electrophoretic displays using these update methods. In one aspect, the invention includes an electrophoretic display, which includes a light-transmissive electrode, an active matrix backplane comprising a plurality of rows of pixel electrodes, each pixel electrode being coupled to a thin-film transistor comprising a gate line and a source line, an electrophoretic medium disposed between the light-transmissive electrode and the active matrix backplane, wherein the electrophoretic medium includes at least three different types of charged pigment particles. The electrophoretic display additionally includes a controller coupled to a plurality of gate lines, each gate line being coupled to the thin-film transistors of one of the plurality of rows of pixel electrodes, and the controller being coupled to a plurality of source lines, the controller further being configured to address the pixel electrodes in a row-by-row fashion by providing both a gate voltage and a source voltage to each thin-film transistor, and non-transitory memory coupled to the controller. The controller is sent instructions from a processor that accesses both a distributed start time look up table (LUT) based upon a noise mask and a look-up table comprising color waveforms (i.e., voltage pulse series), wherein for a transition between a first color and a second color, the color waveform look-up table includes a first waveform for causing the electrophoretic medium to transition between a first color and a second color at a first pixel electrode, and a second waveform for causing the electrophoretic medium to transition between the first color and the second color at a second pixel electrode, wherein the first and second waveforms are identical with respect to a number of voltage pulses and a polarity and magnitude of each of the voltage pulses, but wherein the first and second waveforms are time-shifted by at least 1 ms, e.g., 5 ms, e.g., 8 ms, e.g., 12 ms, according to the first pixel's and the second pixel's location on a noise mask. Additionally, the controller performs the following steps when updating the electrophoretic display between the first image and the second image: receiving the first waveform from the look up table; providing the first waveform to the first pixel electrode; receiving the second waveform from the look up table; and providing the second waveform to the second pixel electrode, where the first pixel electrode and the second pixel electrode are not the same electrode. The controller offsets the start time of at least some of the plurality of waveforms for causing the electrophoretic medium to transition between a first color and a second color based upon the position of the corresponding pixel electrode with respect to the noise mask by adding the offset from the spatial-temporal distributed start time look up table (LUT).

In some embodiments, the spatial temporal noise mask is a blue noise mask or a Brownian noise mask. In some embodiments, the method further comprises using a different spatial-temporal distributed start time look up table (LUT) between a first and a second update to the electrophoretic display. In some embodiments, the look-up table further comprises a third waveform for causing the electrophoretic medium to transition between the first color and the second color at a third pixel, wherein the first, second, and third waveforms are identical with respect to a number of voltage pulses and a polarity and magnitude of each of the voltage pulses, but wherein the first and second and third waveforms are time-shifted by at least 1 ms from each other, according to the first pixel's, and the second pixel's, and the third pixel's location on a noise mask. The controller further performs the step of receiving the third waveform from the look-up table and providing the third waveform to a third row of pixel electrodes adjacent to the second row of electrodes, wherein the second row of electrodes are between the first row of electrodes and the third row of electrodes. In one embodiment, the look-up table further comprises a fourth waveform for a fourth pixel for causing the electrophoretic medium to transition between the first color and a third color, wherein the third waveform is not identical with respect to a number of voltage pulses and a polarity and magnitude of each of the voltage pulses of the first and second waveforms, but wherein the first and second and third waveforms are time-shifted by at least 1 ms from each other according to the first pixel's, the second pixel's, and the third pixel's location on a noise mask. In one embodiment, the first waveform and the second waveform are time-shifted by at least 5 ms, optionally at least 10 ms, optionally time shifted by between 12 ms and 20 ms. In one embodiment, the first waveform and the second waveform are time-shifted by a frame, wherein a frame is the time required to address every pixel in the active matrix backplane one time when addressing the active matrix backplane in a row-by-row fashion. In one embodiment, the magnitudes of the voltage pulses are between −15V and +15V, or between −24V and +24V. In one embodiment, the electrophoretic medium includes a reflective white particle and at least one subtractive color particle or a reflective white particle and at least one reflective color particle. In one embodiment, the electrophoretic medium includes a fourth type of electrophoretic particle. In one embodiment, two of the types of particles are negatively charged and two of the types of particles are positively charged, or wherein one of the types of particles is negatively charged and three of the types of particles are positively charged, or wherein three of the types of particles are negatively charged and one of the types of particles is positively charged. In one embodiment, the electrophoretic medium is encapsulated in microcapsules or microcells.

### BRIEF DESCRIPTION OF DRAWINGS

FIG. 1A is a representative cross-section of a four-particle electrophoretic display wherein the electrophoretic medium is encapsulated in capsules. The construction of FIG. 1A can be used for multi-particle electrophoretic media with both reflective and subtractive pigment particles.

FIG. 1B is a representative cross-section of a four-particle electrophoretic display wherein the electrophoretic medium is encapsulated in microcells. The construction of FIG. 1B can be used for multi-particle electrophoretic media with both reflective and subtractive pigment particles.

FIG. 2 illustrates an exemplary equivalent circuit of a single pixel of an electrophoretic display that uses an active matrix backplane of pixel electrodes coupled to a storage capacitor.

FIG. 3 is a diagrammatic view of an exemplary driving system for controlling voltages provided to pixel electrodes in an active matrix device. The resulting driving voltages can be used to set an optical state of a multi-particle electrophoretic medium.

FIG. 4 illustrates an exemplary electrophoretic display that includes a display module. The electrophoretic display also includes a processor, non-transitory memory, one or more power supplies, and a controller. The electrophoretic display may also include sensors to allow the electrophoretic display to adjust operational parameters based upon the ambient environment, e.g., temperature and illumination.

FIG. 5 illustrates the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 6A shows exemplary push-pull drive schemes for addressing an electrophoretic medium including three subtractive (cyan, yellow, magenta) particles and a scattering (white) particle.

FIG. 6B shows exemplary push-pull drive schemes for addressing an electrophoretic medium including one absorptive (black) particle, two reflective (red, yellow) particles, and a scattering (white) particle.

FIG. 6C shows exemplary drive schemes (waveforms) for addressing an electrophoretic medium including one semitransparent (blue) particle, two reflective (red, yellow) particles, and a scattering (white) particle. The black color state is achieved by presenting a combination of semitransparent blue and red at the viewing surface while the green color state is achieved by presenting a combination of semitransparent blue and yellow at the viewing surface. Notably, the waveforms to achieve the six color states are lengthy and do not have synchronous periods of high or low voltage across the entire waveform.

FIG. 7 depicts an embodiment of the invention wherein a noise mask is used to create a look-up-table (LUT) of pixel start times that is fed to the controller and used to offset the start times on a per-pixel basis.

FIG. 8 illustrates a display of the invention whereby waveforms that are offset in start time are delivered to different pixel electrodes. Some of the waveforms are the same and cause the same optical transition but have difference start times. Some of the waveforms are different because they cause different optical transitions, yet they start at the same time because they have coincidental start times because of the offset due to the noise mask. Some of the waveforms are different and have different start times.

FIG. 9 illustrates a portion of a look-up-table (LUT) that provides a plurality of waveforms for identical color transitions but with different start times.

FIG. 10A illustrates a gray tone noise mask that may be used with the methods of the invention.

FIG. 10B illustrates a gray tone noise mask that may be used with the methods of the invention.

FIG. 11 illustrates that in some embodiments matrices of pixel electrodes are grouped together (dashed box) to use the same waveform from the look up table (LUT) including waveforms offset by a differing number of null frames. Because the pixels are grouped, less processing time is required for the total update.

FIG. 12 illustrates the interplay between the waveforms from the LUT with differing start times and the spatial temporal noise mask, which allows the controller to further modify the start time of each pixel electrode based upon the position of that pixel with respect to the noise mask.

FIGS. 13A-13D illustrates that the spatial temporal noise mask can be adjusted with each update to reduce artifacts due to repeated transitions along the same pixel boundaries because of the spatial temporal noise mask. The adjustment may include using a different noise mask or translating/rotating the same noise mask. Typically, the spatial temporal noise mask takes the form of a look up table (LUT), thus translations and rotations are simply a matter of adjusting from which cell in the LUT the controller is accessing offset numbers.

FIG. 14 illustrates how an image can be converted to a noise mask by performing a Brownian noise transformation on the image.

FIG. 15 shows microscopic close ups of four-pigment electrophoretic displays without (left) and with (right) dynamic shifting of the spatial-temporal noise mask.

### DETAILED DESCRIPTION

The describe methods can be used to decrease the “flashiness” of updates in electrophoretic displays, especially color electrophoretic displays, and typically require very little additional cost in terms of new controllers or drivers. The described methods effectively allow for a per pixel start time to begin their update with little cost in the way of processing power or energy consumption. Additionally, the techniques described below for selected images to be embedded into the transition appearance.

As described below, the visual transition appearance of electrophoretic displays, especially those using complex waveforms that result in visual effects like flickering or flashing, can be made more pleasing to a viewer. Whereas traditional pipelining methods constrain the transition appearance by limiting the updates to certain zones, the described methods achieve a more natural, less distracting transition for complex waveforms. In particular, the methods of the invention use irregular pattern approaches, leveraging varied waveform timing and pixel-level noise mapping across the display. Additionally, selected images, such as a corporate logo, can be easily transformed into a noise mask allowing the display to hint a manufacturer name or other information.

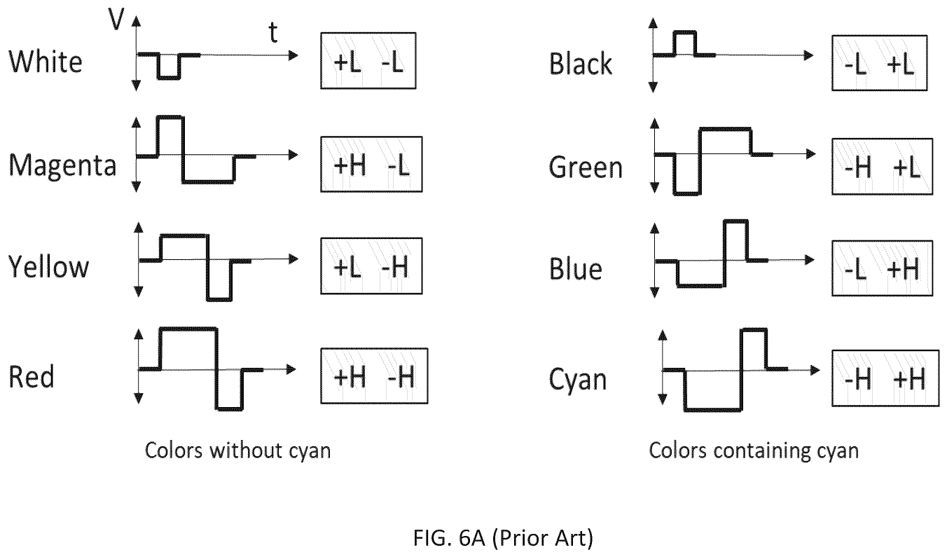

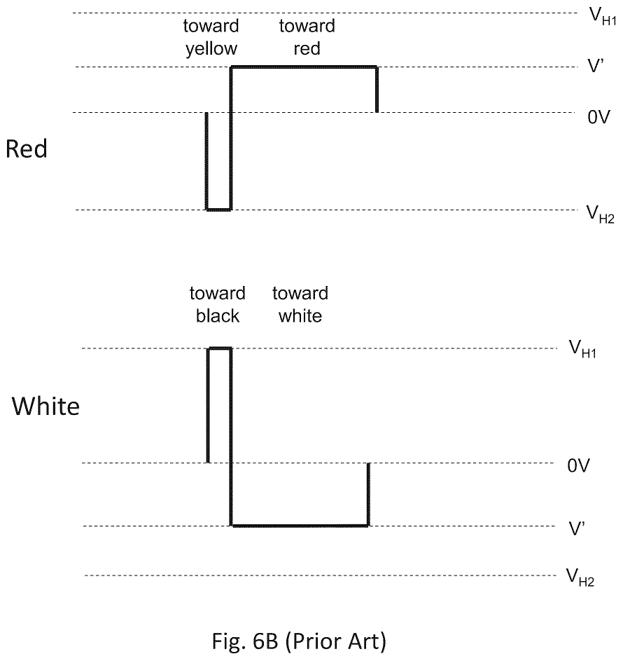

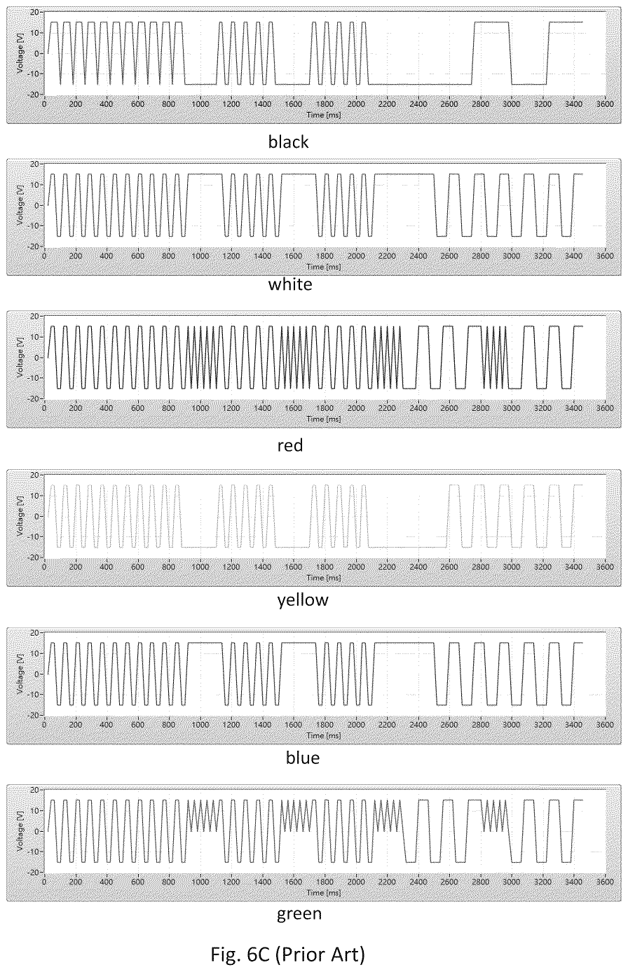

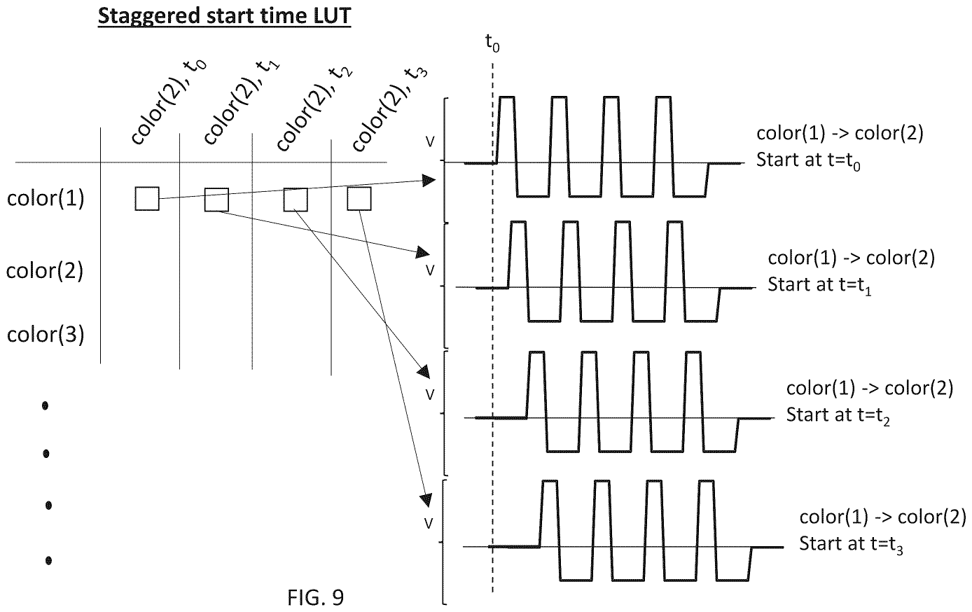

The methods employ a redundant waveform lookup table (LUT) with staggered timing configurations for every color transition in addition to a lookup table (LUT) corresponding to per-pixel spatial mask that is translated into timing offsets based upon the magnitude of the spatial mask mapped onto each pixel. The methods can be used for any existing electrophoretic display. For example, a typical Spectra 6 display (see U.S. Pat. No. 11,868,020), which utilizes six unique waveforms, one for each color, without referencing the previous color state. (See, also, FIG. 6C) To implement the invention, each color transition's waveform maintains a consistent shape of voltage and time, but begins at different frame increments, according to the size of the LUT. For example, the color waveform LUT may have a possible 128 distinct starting times, offset sequentially from frame 0 to frame 127. (See FIG. 9.) The total time offset for the waveform delivered to an individual display pixel corresponds to some combination of the offset selected from the color waveform LUT and the offset for that individual display pixel based upon its position with respect to a noise mask of the same size as the full pixel array. For example, the darkest elements of the noise mask may correspond to pixels having no delay which the lightest elements of the noise mask may correspond to pixels having maximal delay. In an embodiment, this staggered approach creates a total of 768 unique LUT entries (waveforms) across six colors, distributed in starting times across the pixel electrodes. Remarkably, the additional dual LUT entries are not taxing in terms of computing power or energy consumption. The expanded LUT entries fitting comfortably within a 1024 LUT architecture. The noise map is based on pixel positions and is designed to mitigate the flashiness associated with conventional EPD transitions. For a high-definition image (1920×1080), the noise map stores starting times as 7-bit values, supporting up to 128 frame times per pixel. When updating, both the color image and noise map are sent to the controller, which references the staggered LUTs to create a smoother, more continuous transition on the display module.

The invention includes electrophoretic displays with multi-particle electrophoretic media, and improved methods for driving such multi-particle electrophoretic media. Displays of the invention typically include an active matrix backplane of pixel electrodes controlled with thin-film transistors. Typically, each pixel electrode is also couple to a storage capacitor. While the driving methods of displays are generalizable to all different types of electrophoretic displays (segmented, direct drive, indirect drive, active matrix) and may be used with a variety of waveforms, the inventive displays are often used for driving more complicated electrophoretic media, e.g., which require precise control of three, four, or more particles simultaneously. In some embodiments, the displays of the invention use active matrix backplanes controlled with an array of thin-film transistors and the driving waveforms are repetitive “push-pull” types. In some instances, the push-pull waveforms are relatively short, such as would be used for fast page terms. In other instances, the waveforms are longer, having long periods of clearing and particle positioning to provide the best color saturation at the viewing surface. Using the techniques described herein, electrophoretic displays incorporating the disclosed drive schemes will typically appear less “flashy” as compared to addressing with traditional row-by-row updating using a single “best” waveform for a particular color transition, which has been the state of the art for some time. Such displays may include multiple subtractive colored electrophoretic particle and/or multiple reflective colored electrophoretic particles. In some embodiments, the electrophoretic medium includes a white particle and cyan, yellow, and magenta subtractive primary-colored particles, i.e., a WCMY system. In some embodiments, the electrophoretic medium includes two reflective particles, a scattering particle, and a semi-transparent colored particle, i.e., a WRYB* system.

Methods for fabricating an electrophoretic display including four (or more) particles have been discussed in the prior art. The electrophoretic fluid may be encapsulated in microcapsules or incorporated into microcell structures that are thereafter sealed with a polymeric layer. The microcapsule or microcell layers may be coated or laminated to a plastic substrate or film bearing a transparent coating of an electrically conductive material. Alternatively, the microcapsules may be coated onto a light transmissive substrate or other electrode material using spraying techniques. (See U.S. Pat. No. 9,835,925, incorporated by reference herein). The resulting assembly may be laminated to a backplane bearing pixel electrodes using an electrically conductive adhesive. The assembly may alternatively be attached to one or more segmented electrodes on a backplane, wherein the segmented electrodes are driven directly.

Electrophoretic media used herein include charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes, photonic crystals, quantum dots, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The electrophoretic media of the present invention may contain any of the additives used in prior art electrophoretic media as described for example in the E Ink and MIT patents and applications mentioned above. Thus, for example, the electrophoretic medium of the present invention will typically comprise at least one charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

In one embodiment, the present invention uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present invention, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering” or “substantially non-light-scattering”. Specific examples of suitable particles are disclosed in U.S. Pat. No. 9,921,451, which is incorporated by reference herein.

Alternative particle sets may also be used, including four sets of reflective particles, or one absorptive particle with three or four sets of different reflective particles, i.e., such as described in U.S. Pat. Nos. 9,922,603 and 10,032,419, which are incorporated by reference herein. For example, white particles may be formed from an inorganic pigment, such as TiO2, ZrO2, ZnO, Al2O3, Sb2O3, BaSO4, PbSO4 or the like, while black particles may be formed from CI pigment black 26 or 28 or the like (e.g., manganese ferrite black spinel or copper chromite black spinel) or carbon black. The third/fourth/fifth type of particles may be of a color such as red, green, blue, magenta, cyan or yellow. The pigments for this type of particles may include, but are not limited to, CI pigment PR 254, PR122, PR149, PG36, PG58, PG7, PB28, PB15:3, PY138, PY150, PY155 or PY20. Specific examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow.

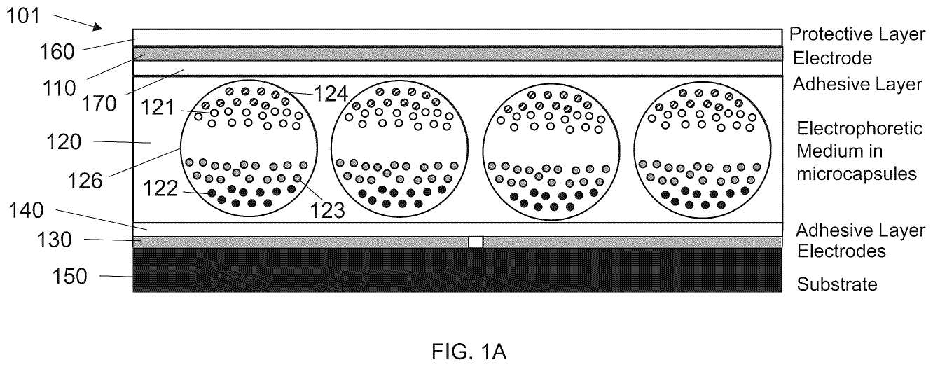

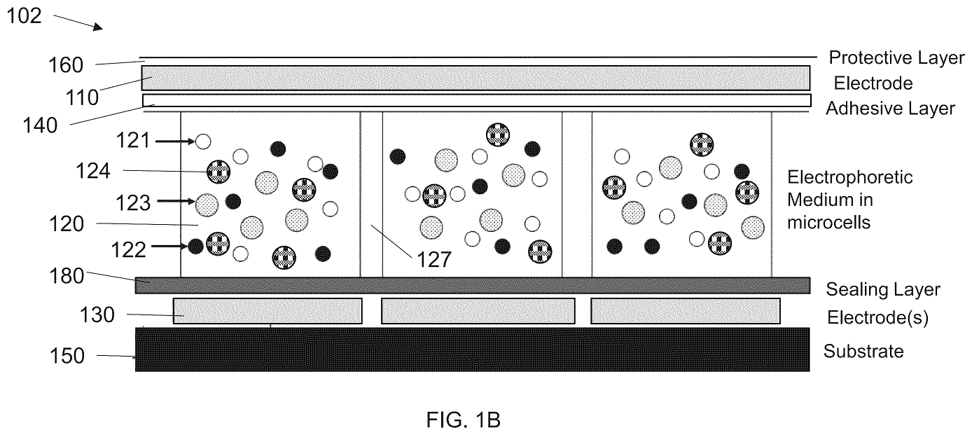

As shown in FIG. 1A and FIG. 1B, an electrophoretic display (101, 102) typically includes a top transparent electrode 110, an electrophoretic medium 120, and a bottom electrode 130, which is often a pixel electrode of an active matrix of pixels controlled with thin film transistors (TFT). In the electrophoretic media 120 described herein, there are four different types of particles, 121, 122, 123, and 124, however more (or fewer) particle sets can be used with the methods and displays described herein. For example the techniques of the invention could be used with a set of three types of particles, for example white, black, and red, wherein one of the three different types of particles has a charge magnitude lower than the other two types of particles. In some instances two of the particles will be positively-charged, and one (or two) of the particles will be negatively-charged. In some instances one of the particles will be positively-charged, and three particles will be negatively-charged. In some instances one of the particles will be negatively-charged, and three particles will be positively-charged. The electrophoretic medium 120 is typically compartmentalized such by a microcapsule 126 or the walls of a microcell 127. An optional adhesive layer 140 can be disposed adjacent any of the layers, however, it is typically adjacent an electrode layer (110 or 130). There may be more than one adhesive layer 140 in a given electrophoretic display (105, 106), however only one layer is more common. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include sealing layers 180 as needed. In some embodiments the adhesive layer 140 may include a primer component to improve adhesion to the electrode layer 110, or a separate primer layer (not shown in FIG. 1B) may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

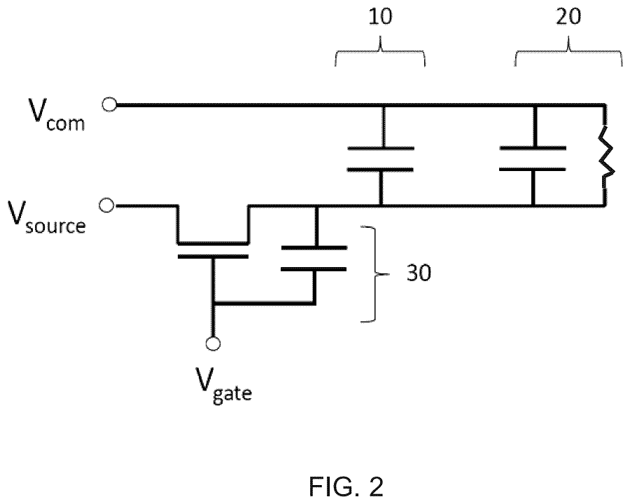

In some embodiments, e.g., as shown in FIG. 1A, the electrophoretic display may include a light-transmissive electrode, an electrophoretic medium, and a plurality of rear pixel electrodes. To produce a high-resolution display, e.g., for displaying images, each pixel electrode 130 is individually-addressable without interference from adjacent pixels so that an image file is faithfully reproduced on the display. One way to achieve this objective is to provide an array of non-linear elements, such as transistors or diodes, with at least one non-linear element associated with each pixel, to produce an “active matrix” display. (See FIG. 2.) An addressing or pixel electrode 130, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor.

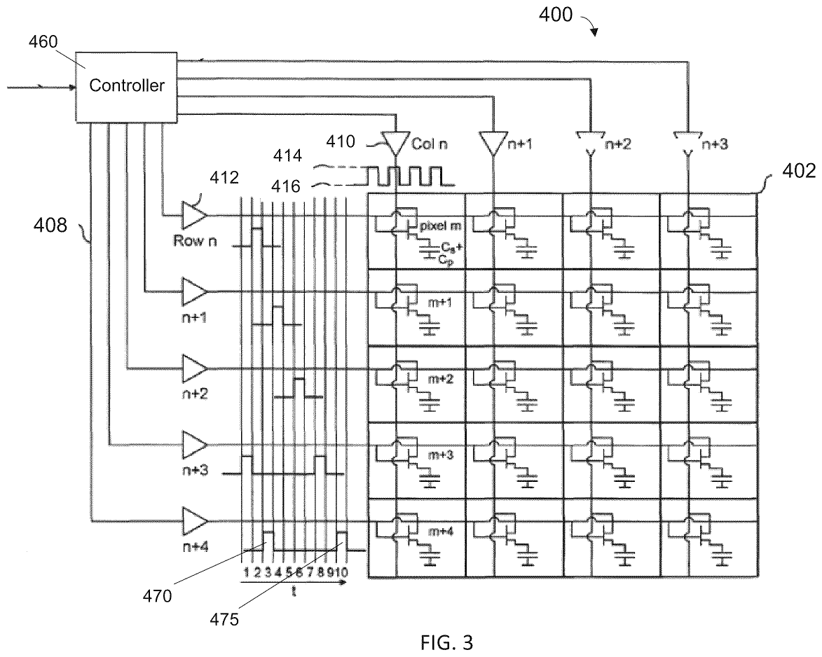

Conventionally, in high resolution arrays, the pixels are arranged in a two-dimensional array of rows and columns, such that any specific pixel is uniquely defined by the intersection of one specified row and one specified column. (See FIG. 3) The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are typically connected to a row driver (gate driver, gate controller), which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are typically connected to column drivers (source driver, source controller), which place upon the various column electrodes voltages selected to drive the pixels in the selected row to their desired optical states. (The aforementioned voltages are with respect to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed so that the next line of the display is written. This process is repeated so that the entire display is written in a row-by-row manner. The time between addressing in the display is known as a “frame.” Thus, a display that is updated at 60 Hz has frames that are 16 msec. A display that is updated at 85 Hz has frames that are 12 msec. A display that is updated at 120 Hz has frames that are 8 msec.

It should be noted that the magnitude of the voltage that can be provided in such row-column driving can be limited by the materials from which the non-linear element, e.g., thin film transistor, is fabricated. In many embodiments the semiconductor material is silicon, especially amorphous silicon, which is able to control driving voltages on the order of ±15 V. In other embodiments, the semi-conductor of the thin-film-transistor may be a metal oxide, such indium gallium zinc oxide (IGZO), which allows for a wider range of driving voltages, e.g., up to ±30 V e.g., as described in U.S. Patent Publication No. US 2022/0084473. This design feature is particularly pertinent when driving waveforms to sort the pigments of a multi-particle system. In such systems, it is beneficial to provide at least five voltage levels (high positive, low positive, zero, low negative, high negative), and with higher total voltages, it is easier to separate the particles. For greater details, see U.S. Patent Publication 2021-0132459.

FIG. 2 of the accompanying drawings depicts an exemplary equivalent circuit of a single pixel of an electrophoretic display. As illustrated, the circuit includes a storage capacitor 10 formed between a pixel electrode (element 130 of FIGS. 1A and 1B) and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. [In some embodiments, to compensate for the unwanted “kickback voltage”, a common potential Vcom, may be supplied to the top plane electrode and the capacitor electrode associated with each pixel, such that, when Vcom is set to a value equal to the kickback voltage (VKB), every voltage supplied to the display may be offset by the same amount, and no net DC-imbalance experienced.]

In a conventional electrophoretic display using an active matrix backplane, each pixel electrode has associated therewith a capacitor electrode (storage capacitor) such that the pixel electrode and the capacitor electrode form a capacitor; see, for example, International Patent Application WO 01/07961. In some embodiments, N-type semiconductor (e.g., amorphous silicon) may be used to from the transistors and the “select” and “non-select” voltages applied to the gate electrodes can be positive and negative, respectively.

Additional details of the row-column addressing used in an “active matrix” backplane 400 are shown in FIG. 3. An addressing or pixel electrode, which addresses one pixel, is fabricated on a substrate 402 and connected to the appropriate voltage sources through the associated non-linear elements. It is understood that the voltage sources 404 and 406 may originate from separate circuit elements or the voltages can be delivered with the assistance of a single power supply and a power management integrated circuit (PMIC). In some instances an intervening source controller is used to control the supplied voltage, however in other embodiments the controller 460 is configured to control the entire addressing process, including coordinating the gate and source lines. A state-of-the-art timing controller (T-Con, available from E Ink Corporation) way come preloaded with a 32×32 LUT of waveforms specific to the electrophoretic particle set. It is also to be understood that FIG. 3 is an illustration of the layout of an active matrix backplane 400 but that, in reality, the active matrix has depth and some elements, e.g., the TFT, may actually be underneath the pixel electrode, with a via providing an electrical connection from the drain to the pixel electrode above.

Conventionally, in high resolution arrays, the pixels are arranged in a two-dimensional array of rows and columns, such that any specific pixel is uniquely defined by the intersection of one specified row and one specified column. The sources of all the transistors in each column are connected to a single column (scan) line 406, while the gates of all the transistors in each row are connected to a single row (gate) line 408; again the assignment of sources to rows and gates to columns is conventional but essentially arbitrary, and could be reversed if desired. The gate lines 408 are optionally connected to a gate line driver 412, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column scan lines 406 are optionally connected to scan line drivers 410, which place upon the various scan lines 406 voltages selected to drive the pixels in the selected row to their desired optical states. (The aforementioned voltages are relative to a common top electrode, and is not shown in FIG. 3.) With conventional driving, after a pre-selected interval known as the “line address time” the selected row is deselected, the next row is selected, and the voltages on the column drivers are changed so that the next line of the display is written. This process is repeated in a linear fashion so that the entire display is written in a row-by-row manner. As shown in FIG. 3, the temporal spacing between gate voltage pulses of respective frames is typically constant, and represent the rhythm of line by line addressing. Notably, the invention does not implement an even spacing between respective gate voltage pulses for a given address row of pixel electrodes.

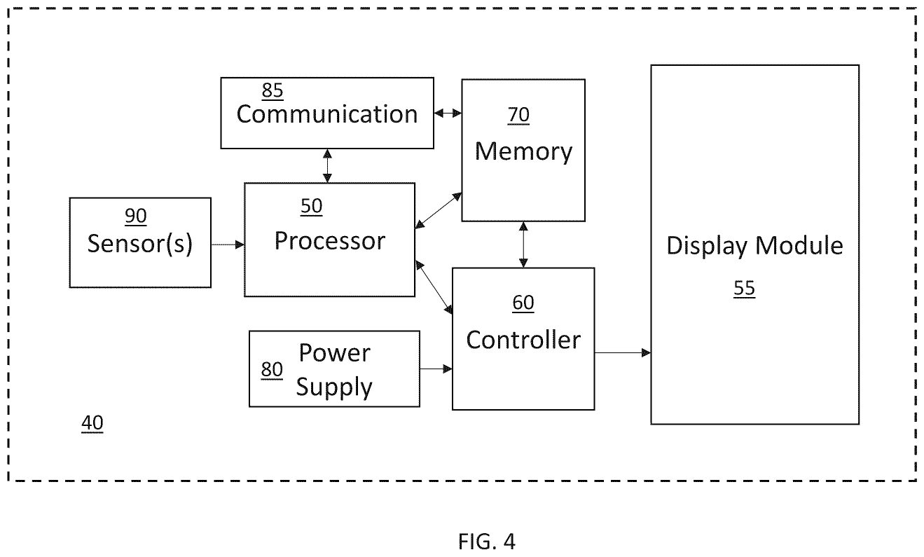

The active matrix backplane described with respect to FIG. 3 is coupled to an electro-optic medium, e.g., as illustrated in FIGS. 1A and 1B, and typically sealed to create a display module 55, as shown in FIG. 4. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. Of course, if the electrophoretic display is being used as a sensor or counter, the content may relate to other inputs. The processor is typically a mobile processor chip, such as made by Freescale or Qualcomm, although other manufacturers are known. The processor is in frequent communication with the non-transitory memory 70, from which it pulls image files and/or look up tables to perform the color image transformations described below. The non-transitory memory 70 may also include gate driving instructions to the extent that a particular color transition may require a different gate driving pattern. The electrophoretic display 40 may have more than one non-transitory memory chip. The non-transitory memory 70 may be flash memory. In many embodiments, the non-transitory memory 70 is incorporated directly into the end consumer device by incorporating all of the elements of FIG. 4 into a circuit board or package. However, in some instances, the driving circuitry is not directly incorporated into the display, such as when the display becomes the exterior of an object such as an automobile.

Waveforms (discussed below) are typically stored in the non-transitory memory 70, however they can also be incorporated into the controller 60 or the processor 50 or they can be stored on the cloud and downloaded via communications 85. A number of look-up tables can be used to facilitate the methods of the invention, especially to provide time shifted waveforms to the controller 60 and timing offsets according to a desired noise mask, as appropriate. In particular for a given transition from a first color to a second color in an electrophoretic medium having eight primaries a look up table could include instructions for updating from color 1 to a later color (with no time offset) in look-up slots 1 to 8, while instructions for updating from color 1 to a later color (with a first time offset) in look-up slots 9 to 16, and instructions for updating from color 1 to a later color (with a second time offset) in look-up slots 17 to 24, and so on. Of course, this type of look-up table can also be indexed for improved performance in view of operating conditions, such as device temperature, battery health, front-light color, front-light intensity, etc.

Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip (PMIC). The electrophoretic display 40 may additionally include communication 85, which may be, for example, WIFI protocols or BLUETOOTH, and allows the electrophoretic display 40 to receive images and instructions, which also may be stored in memory 70. The electrophoretic display 40 may additionally include one or more sensors 90, which may include a temperature sensor and/or a photo sensor, and such information can be fed to the processor 50 to allow the processor to select an optimum look-up-table when such look-up-tables are indexed for ambient temperature or incident illumination intensity or spectrum. In some instances, multiple components of the electrophoretic display 40 can be embedded in a singular integrated circuit. For example, a specialized integrated circuit may fulfill the functions of processor 50 and controller 60.

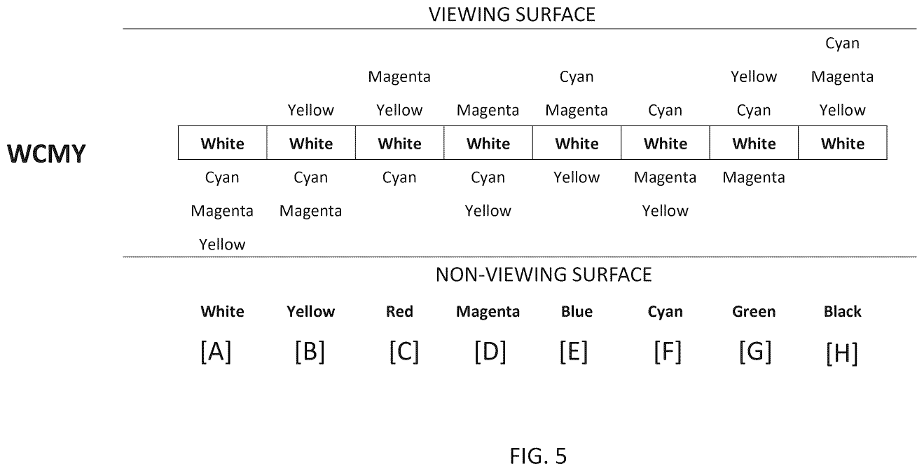

As shown in FIG. 5, the ACEP (e.g., WCMY) system in principle works similar to printing on bright white paper in that the viewer only sees those colored pigments that are on the viewing side of the white pigment (i.e., the only pigment that scatters light). In FIG. 5, it is assumed that the viewing surface of the display is at the top (as illustrated), i.e., a user views the display from this direction, and the illumination light is also incident from this direction. In FIG. 5 the light scattering particle is assumed to be the white pigment. This light-scattering white particle forms a white reflector against which any particles above the white particles (as illustrated in FIG. 5) are viewed. A portion of the incident light passes through the subtractive particles, is reflected from the white particles below the subtractive particles, passes back through these particles and emerges from the display. A different portion of the incident light is absorbed by the subtractive particles. Thus, the particles above the white particles may absorb various colors and the color appearing to the user is that resulting from the combination of particles above the white particles. Any particles disposed below the white particles (behind from the user's point of view) are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 5), there are no particles above the white particles and the pixel simply displays a white color. When a single particle is above the white particles, the color of that single particle is displayed, yellow, magenta and cyan in Situations [B], [D] and [F] respectively in FIG. 5. When two particles lie above the white particles, the color displayed is a combination of those of these two particles; in FIG. 5, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 5), all the incoming light is absorbed by the three subtractive primary colored particles and the pixel displays a black color.

It is possible that one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering colored particle cannot lie over the non-scattering colored particles (otherwise they will be partially or completely hidden behind the scattering particle and the color rendered will be that of the scattering colored particle, not black).

FIG. 5 shows an idealized situation in which the colors are uncontaminated (i.e., the light-scattering white particles completely mask any particles lying behind the white particles). In practice, the masking by the white particles may be imperfect so that there may be some small absorption of light by a particle that ideally would be completely masked. Such contamination typically reduces both the lightness and the chroma of the color being rendered. In the electrophoretic medium of the present invention, such color contamination should be minimized to the point that the colors formed are commensurate with an industry standard for color rendition. A particularly favored standard is SNAP (the standard for newspaper advertising production), which specifies L*, a* and b* values for each of the eight primary colors referred to above. (Hereinafter, “primary colors” will be used to refer to the eight colors, black, white, the three subtractive primaries and the three additive primaries as shown in FIG. 5.)

FIG. 6A shows push-pull waveforms (in simplified form) used to drive a four-particle WCMY electrophoretic display system described above. Such waveforms consist of a dipole comprising two pulses of opposite polarity. Typically, each dipole has a pulse of voltage V1 applied for a time t1 followed by a voltage V2 applied for time t2. The dipole is impulse balanced when V1t1+V2t2=0.The magnitudes and lengths of these pulses determine the color obtained. At a minimum, there should be five such voltage levels. FIG. 6A shows high and low positive and negative voltages, as well as zero volts. Typically, “low” (L) refers to a range of about five-15V, while “high” (H) refers to a range of about 15-30V. In general, the higher the magnitude of the “high” voltages, the better the color gamut achieved by the display. In some instances, especially where more colors are required, there medium voltages are also included. The “medium” (M) level is typically around 15V; however, the value for M will depend somewhat on the composition of the particles, as well as the environment of the electrophoretic medium.

Notably with the dipole waveforms of FIG. 6A, the dipoles used to provide magenta, yellow, green and blue colors are at least approximately impulse balanced. On the other hand, it is not necessary to use dipole addressing to produce black and white. Simple monopole pulses in either direction will move the oppositely-charged colored and white pigments towards and away from the viewing surface, and thus the display behaves under these circumstances like a conventional display containing black and white pigments. Additionally, because these monopole pulses are not DC balanced, additional charge clearing pulses must be incorporated into the device drive protocol, either at the beginning or end of an image update, or at the end of an extended unbalanced drive sequence, such as may happen when scrolling text. Dipole addressing can break the symmetry even when the waveform is impulse balanced overall, however. For example, one can have ∫Vdt=0, and ∫V³dt≠0. See, e.g., Dukhin A S, Dukhin S S, “Aperiodic capillary electrophoresis method using an alternating current electric field for separation of macromolecules.” Electrophoresis, 2005 Jun;26(11):2149-53. Then, as long as pigment mobility depends on applied electric field, this kind of waveform can result in overall pigment drift.

FIG. 6B shows two typical push-pull waveforms that are used to cause the color of the lesser charged particles to appear at the viewing surface for a four particle system including a scattering white particle, an absorptive black particle, and two colored scattering particles (yellow and red). See, e.g., U.S. Pat. No. 10,339,876. In the instance depicted in FIG. 6B, the yellow particle is highly charged with a negative polarity and the white particle has lower charge with a negative polarity. The black particle is highly charged with a positive polarity and the red particle has lower charge and a positive polarity.

FIG. 6C shows six color waveforms that can be used to address the color of the viewing surface for a four particle system including a scattering white particle, an semi-transparent blue particle, and two colored scattering particles (yellow and red). See, e.g., U.S. Pat. Nos. 11,868,020 and 11,640,803. In the instance depicted in FIG. 6C, the yellow particle is highly charged with a negative polarity and the white particle has lower charge with a negative polarity. The semitransparent blue particle is highly charged with a positive polarity and the red particle has lower charge and a positive polarity. Notably, the six different waveforms are quite long (greater than 3 seconds) and they all contain extended periods of “shaking”, i.e., transitioning between high and low voltage. When all of the pixels in an electrophoretic display of this type begin their updates at the same time, the visual effect can be off-putting.

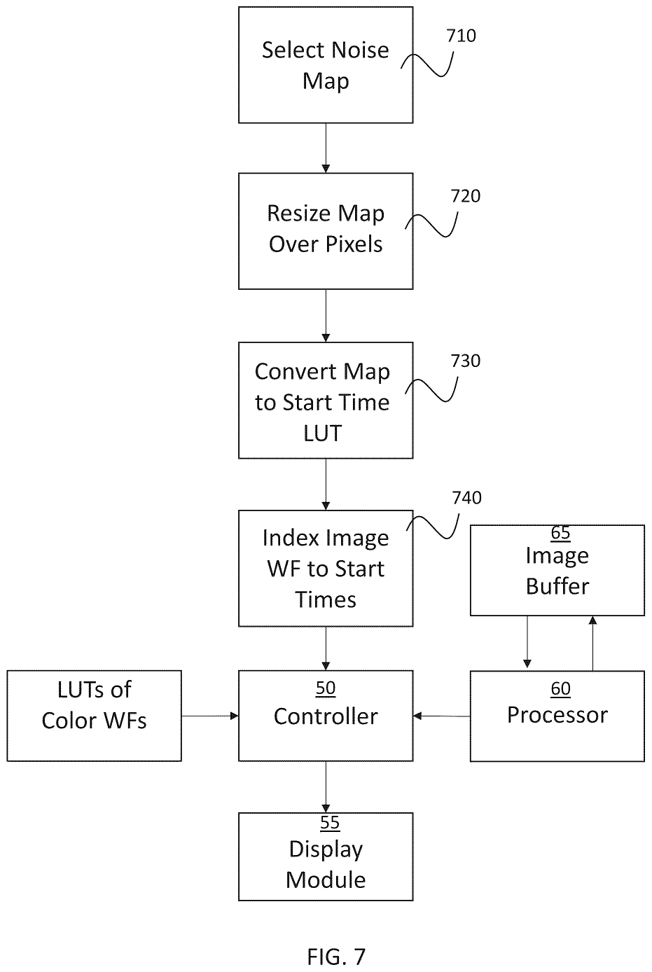

A flow chart in FIG. 7. illustrates the generalized method of delaying the individual waveform updates to reduce the flashiness of the image updates. At step 710 a noise map (mask) is selected. Any noise mask can be used, however empirical measurements suggest that masks with more gradual spatial transitions are more pleasing. For example, a blue noise (BN) mask can be used as the map. A blue noise pattern is commonly used in image processing due to its spatial uniformity. When applied as a noise map, blue noise helps diffuse the high-contrast transitions, creating a noisier but smoother transition that appears gradually rather than flashy update. Blue noise is particularly effective on larger displays where smooth transitions are desirable.

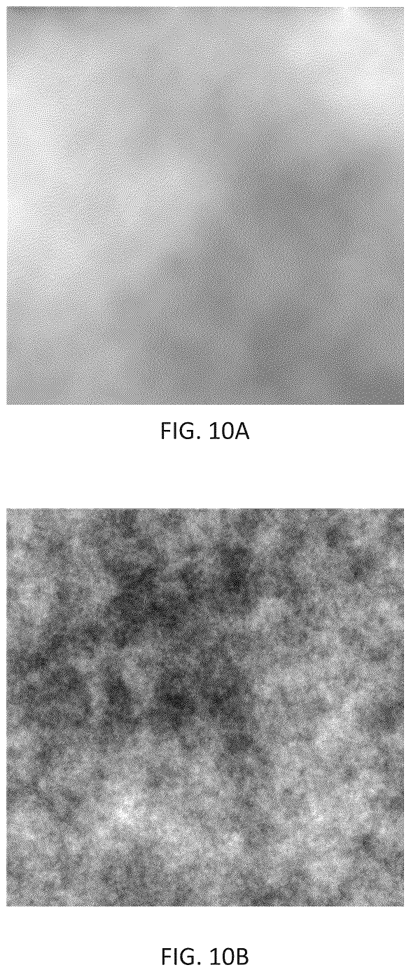

One drawback to using blue noise is the appearance of undesired colors between pixel gaps, due to pixel blooming, leading to a slight “ghosting” effect that can degrade color accuracy. Empirical measurements confirm that Brownian noise, especially Brownian noise maps created using midpoint displacement or fractional Gaussian techniques, provide smoother transitions, which results in fewer artifacts. Brownian noise offers a less rigid, more organic appearance that mimics an animated transition effect without excessive flashing. Midpoint displacement has proven particularly effective for minimizing pixel-gap artifacts and delivering a visually appealing transition. Other smoother maps can be created using fractional Gaussian transforms, fast Fourier transform (FFT), and cumulative sums of white noise. In particular, midpoint displacement produces the best balance of smooth transitions and artifact reduction, whereas other methods like random walk or wavelet transform are less effective for this purpose given the same frequency response result as the four methods mentioned above. See e.g., the Brownian noise mask examples in FIGS. 10A and 10B.

Once the noise mask has been selected, it must be sized to overlay the pixels of the display module in step 720. This is done using known techniques, and if the resolution of the display module exceeds the resolution of the noise mask, the noise mask can be stretched without any detriment to the overall update effect. Once the map has been sized, the pixels of the noise map are transformed to start-time-offsets in step 730 to create a spatial-temporal distributed start time look up table (LUT). For example, pixels in the noise mask having the darkest pixels may correspond to no time offset, while pixels in the noise mask having the lightest pixels may correspond to many frames of offset in starting time. The start time offsets are then combined with the LUT of color transitions to produce an expanded LUT of time and space offset color updates that will be applied to the image that is received by the controller 50, typically via a processor 60, which is in communication with an image buffer 65, i.e., some memory. The LUT of color transitions may also include staggered starting times, as discussed below, however this is not necessary. For example, the start times for the six waveforms of FIG. 6C (box 750 of FIG. 7) may be offset sequentially from frame 0 to frame 127 according to the noise map (box 730 of FIG. 7). Accordingly, this staggered approach creates a total of 768 unique LUT entries (waveforms) across six colors, distributed in starting times across the pixel electrodes, i.e., box 740 of FIG. 7. Finally, the controller 50 will send the appropriate voltage and time pulses to the display module 55 to produce the image update with spatially distributed start times for the individual display pixels.

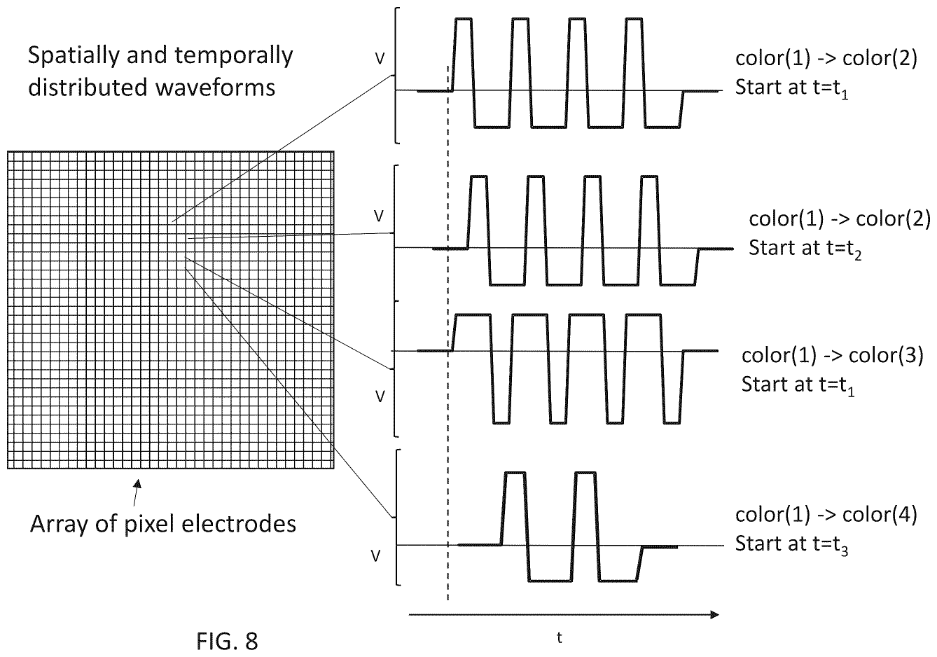

FIG. 8 illustrates, in a general sense, the interplay of the same waveform, time-shifted in two forms and stored in a look up table in the non-transitory memory, as well as different waveforms that start at the same time as one of the time-shifted two waveforms, and a fourth waveform that is different in both time, shape, and space. Using this technique, the overall color update from image 1 to image 2 is only lengthened by hundreds of milliseconds, which is not noticeable over the course of a three second update. A further benefit of the interlacing time-shifted pattern of FIG. 8 is that technique evens out the current draw for the gate drivers, especially when large portions of the display are being driven between the same colors during an image update. Whereas with normal driving, all of the gate lines in an update area draw current at roughly the same time, as defined by the push-pull waveforms, the interlaced time-shifted driving results in fewer gate lines simultaneously drawing full current. In some instances, the reduction in current swings will allow for less expensive electrical components to be used in the device. In some instances, this current levelling will result in less power drain, therefore the battery charge will last longer for the same number of updates. In other embodiments, gate line direction scanning with interlacing allows that current to be drawn in mostly the same way as non-interlaced examples. Also, if interlacing were to be used with the source drivers (i.e., through the source lines), the misalignment of the waveform with interlacing could result in large overhead in current consumption than normal, as the voltages needs to be switched more often even with a uniform color patch.

A further illustration of a look up table with time-shifted waveform start times is shown in FIG. 9. Only a small portion of the LUT is shown, but it illustrates that for a transition between a first color and a second color, many waveforms having the same number of voltage pulses of the same polarity and the same magnitude, as needed to drive the color(1)->color(2) transition are provided with a different number of null frames (0V frames) at the beginning of the push pull structure. Of course, it should be realized that the number of staggered waveforms for a given color transition is somewhat arbitrary, however typically 64 staggered waveforms or 128 staggered waveforms are more often provided for each color transition. Additionally, a same number of staggered waveforms is also provided for every other color transition contemplated for the available color set, e.g., color(3)->color(2). Thus, for six primary colors, such a LUT using e.g., 128 staggered waveforms for each of the 25 possible color transitions (assuming that no transition is necessary to maintain the same color between a first and second image), will have total of 3200 entries, each having a unique waveform with respect to time zero that can be provided to a display pixel by the controller.

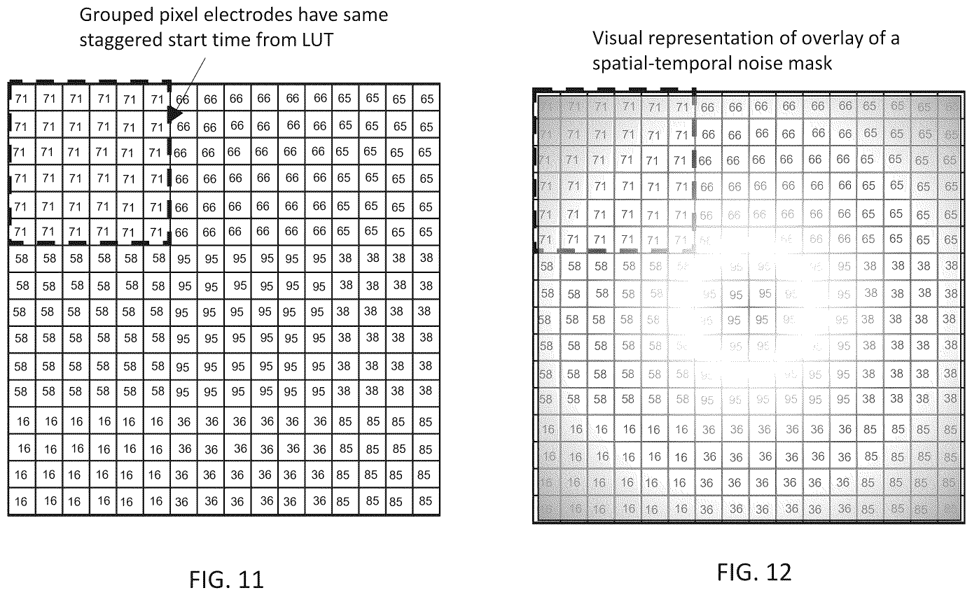

In order to reduce the processing power required to calculate the accumulated offsets created by the combined LUTs, the pixel electrodes of an active matrix backplane can be grouped together by offset number, as shown in FIG. 11. As shown in FIG. 11, groups of 6 pixel by 6 pixel matrices all have the same starting offset (i.e., “71” frames. “65” frames, “58” frames). For example, all of the pixels inside the dashed bounding box that are undergoing a color transition during an update will have a 71 frame delay, regardless of the color transition(s). Through trial and error, it appears that groups of 4×4 to 10×10 pixels have the most pleasing transitions. In particular, 6×6 or 7×7 or 8×8 pixel groupings have the best balance of optical appearance and reduced processing requirements.

As noted above, Brownian noise patterns, such as shown in FIGS. 10A and 10B show the best results. In particular, midpoint displacement produces the best balance of smooth transitions and artifact reduction, whereas other methods like random walk or wavelet transform are less effective for this purpose given the same frequency response result as the four methods mentioned above. However, many other noise masks can be used, i.e., as illustrated in FIG. 12. In FIG. 12, a simple radial noise mask is used to demonstrate how the spatial temporal noise mask might overlay on the active matrix backplane with grouped pixels that are also using staggered start times from the color transition LUT (FIG. 9). As discussed above, the darker areas of the radial mask would correspond to pixels that are not receiving an additional temporal offset while the brighter areas correspond to pixels that are receiving the greatest additional temporal offset. Typically, the total additional temporal offset due to the spatial temporal mask is from 0 frames to 24 frames. However, a greater range of additional temporal offset can be used, such as 0 frames to 64 frames, or 0 frames to 128 frames, can be used. A lesser range of additional temporal offset may also be used, i.e., from 0 to 8 frames, or 0 to 16 frames.

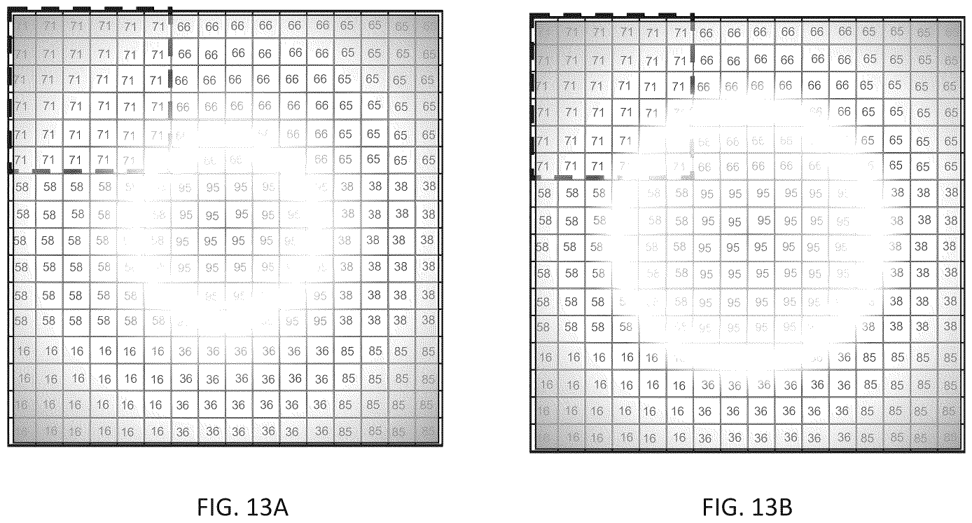

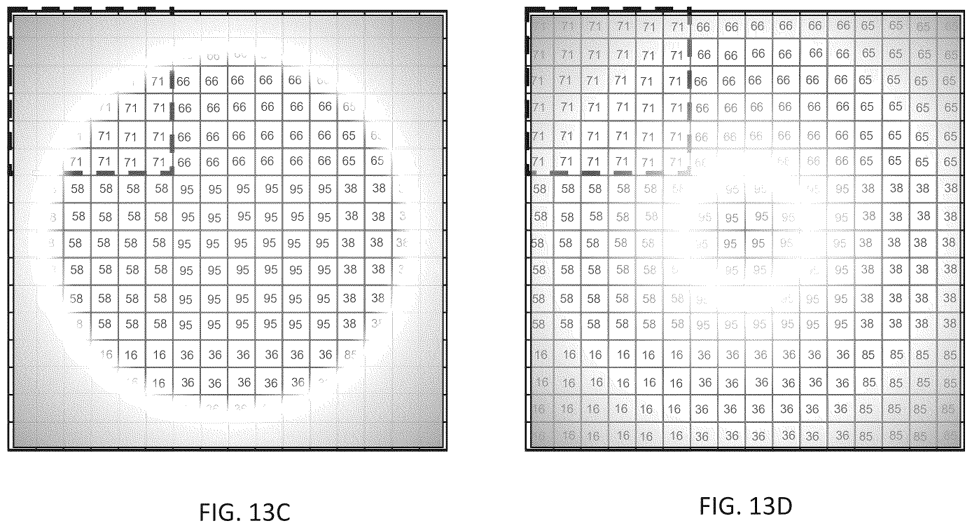

Unfortunately, due to the nature of electrophoretic display, and the spread of electric field lines during updates, repeated updates using the same bounding boxes of staggered start times and/or the same spatial temporal noise masks results in image artifacts, especially at the edges between high and low features in the spatial temporal noise mask. Accordingly, it is further beneficial to dynamically shift the spatial temporal noise mask between updates as illustrated in FIGS. 13A-13D. For example, the shape of the noise mask can be modified between subsequent updates, as illustrated in FIG. 13A->FIG. 13B->FIG. 13C->FIG. 13D, etc. It is also possible, and requires less processing, to simply translate or rotate the spatial temporal noise mask between updates. For example, the spatial temporal noise mask can simply move one pixel up or down between each image update. It is also possible to simply cycle through a number of translations to further reduce the number of translations. In particular, it has been found that marching the spatial temporal noise mask across the extents of a bounding box of similarly-delayed pixel electrodes greatly reduces image artifacts (see Example). Pragmatically, marching the spatial temporal noise mask between updates can be easily accomplished by instructing the controller to simply start from a different position in the LUT with subsequent updates, for example calling from row n of the spatial-temporal distributed start time look up table (LUT) for the first update and from row n+1 for the second update and from row n+2 for the second update, etc.

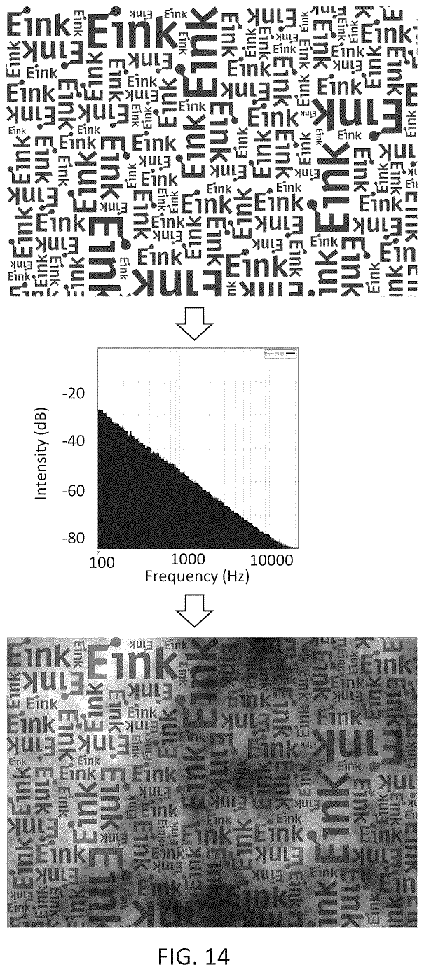

In some instances, it is desirable to add another dimension to the Brownian mask by transforming an image, such as a design, a logo, or a picture to add Brownian noise and then use the resulting noise map to determine the time delays. FIG. 14 illustrates how an arbitrary image can be the basis for the noise mask for the method of the invention. For example, an image (top of FIG. 14) is converted to grayscale and scaled to fit the desired starting frame range (128 levels). A Fourier Transform (FFT) is applied and filtered in a Brownian noise pattern to produce the noise mask (bottom of FIG. 14). During image updates, this noise map briefly displays the image (such as a logo), which fades as the update completes, offering a unique yet unobtrusive transition effect. This invention enables smoother EPD transitions by combining advanced waveform timing, noise mapping, and artifact-reduction techniques, delivering a visually appealing, less disruptive update experience.

It should be noted that the techniques described herein are not limited to active-matrix backplanes because adjacent segmented displays can also take advantage of time-shifted waveforms to decrease flash, especially when using repeating push-pull waveforms to drive a color transition. Furthermore, the techniques are not limited to repeating push-pull waveforms because more complicated waveforms, which are not simple push-pull can be offset in time to provide a less flashy transition.

### EXAMPLE

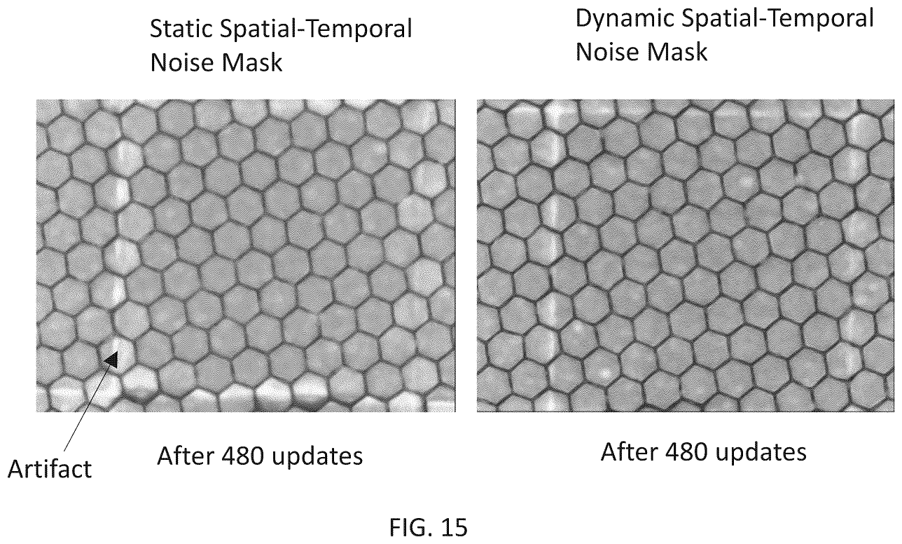

An active matrix, 4″ diagonal, Spectra 6 display (white, red, yellow, semitransparent blue particles; E Ink Corporation) was driven through 480 white-to-green transitions using the same look up tables of time shifted waveforms, parsed into 6 pixel by 6 pixel groups, combined with a blue noise (BN) spatial temporal mask. FIG. 15 shows the results (under microscope) without (left) and with (right) dynamic shifting of the spatial temporal mask between updates. In the dynamic shift example, the BN mask was mathematically translated diagonally one pixel from upper left to lower right on the active matrix backplane between each update. (A separate mask was not used for each update.) The BN mask was shifted one pixel between updates six consecutive times and then returned to the original position. As shown in FIG. 15, the static BN mask exhibits thicker boundary lines and noticeable blooming artifacts, which degrades the overall EO quality. In contrast, the dynamic shifting significantly reduces boundary thickness and clears prior artifact lines, resulting in improved EO performance. As shown in FIG. 15, using a dynamic spatial temporal mask effectively mitigates residual blooming artifacts and resets the update history, resulting in a smaller EO change that stabilizes after approximately 300 updates. While it is not immediately evident from the microscope images, when this same field is viewed from farther away (approximately 50 cm), the green color in the sample using the dynamic mask shifting looks “richer” and “more green” because the artifacts tend to make colors look “washed out” at a distance. Performing the same test for different color updates, i.e., white to blue, showed better results with the dynamic noise mask, however the overall optical difference is most noticeable for green updates because of the human eye's natural sensitivity to differing shades of green.

The invention allows a non-flashing update of a multi-pigment color display without requiring substantial modification to the driving electronics. Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A method for updating an electrophoretic display, the electrophoretic display including:
a light-transmissive electrode,
an active matrix backplane comprising rows of pixel electrodes, wherein each pixel electrode is coupled to a thin-film transistor, and each thin-film transistor is coupled to a gate line and a source line,
an electrophoretic medium disposed between the light-transmissive electrode and the active matrix backplane, wherein the electrophoretic medium includes at least three different types of charged pigment particles,
a controller coupled to a plurality of gate lines, each gate line being coupled to thin-film transistors of a row of pixel electrodes, and the controller being coupled to a plurality of source lines, the controller being configured to address the pixel electrodes in a row-by-row fashion by providing both a gate voltage and a source voltage to each thin-film transistor,
a processor coupled to the controller, and
non-transitory memory coupled to the processor and the controller,
wherein the method for updating the electrophoretic display comprises:
accessing a color waveform look up table (LUT) including a plurality of waveforms for causing the electrophoretic medium to transition between a first color and a second color wherein each of the plurality of waveforms is offset by a different number of null frames such that a number of voltage pulses and a polarity and magnitude of each of the voltage pulses to cause the transition between the first color and the second color is the same, but wherein each waveform begins at a different time;
accessing a spatial-temporal distributed start time look up table (LUT) including an offset start time based upon the position of each pixel electrode with respect to a noise mask that spans the area of the active matrix;
offsetting the start time of at least some of the plurality of waveforms for causing the electrophoretic medium to transition between a first color and a second color based upon the position of the corresponding pixel electrode with respect to the noise mask by adding the offset from the spatial-temporal distributed start time look up table (LUT);
sending instructions from the controller to the respective gate and scan lines so that pixel electrodes of the active matrix backplane cause the electrophoretic medium to transition between the first color and the second color with different start times.

2. The method of claim 1, wherein the spatial-temporal distributed start time look up table corresponds to blue noise mask or a Brownian noise mask.

3. The method of claim 2, wherein the look up table corresponds to a Brownian noise mask with midpoint displacement.

4. The method of claim 1, further comprising using a different spatial-temporal distributed start time look up table (LUT) between a first and a second update to the electrophoretic display.

5. The method of claim 4, further comprising using a second different spatial-temporal distributed start time look up table (LUT) between the second and a third update to the electrophoretic display.

6. The method of claim 4, wherein the first and the second updates are consecutive updates.

7. The method of claim 1, further comprising using a same spatial-temporal distributed start time look up table (LUT) between a first and a second update to the electrophoretic display, wherein the controller accesses row n of the spatial-temporal distributed start time look up table (LUT) for the first update and row n+1 for the second update.

8. The method of claim 1, wherein some pixel electrodes are grouped together to form a group and the controller accesses color transition waveforms having a same delay time for all of the pixel electrodes in the group.

9. The method of claim 8, wherein the group is a matrix of 6×6 pixel electrodes.

10. The method of claim 1, wherein different pixel electrodes have start times that differ by at least 5 ms.

11. The method of claim 1, wherein the electrophoretic medium includes a reflective white particle and at least one subtractive color particle or a reflective white particle and at least one reflective color particle.

12. The method of claim 1, wherein the electrophoretic medium includes a fourth type of electrophoretic particle.

13. The method of claim 12, wherein two of the types of particles are negatively charged and two of the types of particles are positively charged, or wherein one of the types of particles is negatively charged and three of the types of particles are positively charged, or wherein three of the types of particles are negatively charged and one of the types of particles is positively charged.
